(19) United States
(12) Patent Application Publication
(10) Pub. No.: US 2023/0371137 A1
(43) Pub. Date: Nov. 16, 2023

(54) COOKING APPARATUS, METHOD FOR CONTROLLING COOKING APPARATUS, AND KNOB CAPABLE OF CONTROLLING COOKING APPARATUS

(71) Applicant: SAMSUNG ELECTRONICS CO., LTD., Suwon-si (KR)

(72) Inventors: Sunghyun SONG, Suwon-si (KR); Hyeongseong KIM, Suwon-si (KR); Nooree NA, Suwon-si (KR); Taehyoung CHO, Suwon-si (KR)

(73) Assignee: SAMSUNG ELECTRONICS CO., LTD., Suwon-si (KR)

(21) Appl. No.: 18/226,486

(22) Filed: Jul. 26, 2023

Related U.S. Application Data
(63) Continuation of application No. PCT/KR2022/001858, filed on Feb. 7, 2022.

(30) Foreign Application Priority Data
Feb. 17, 2021 (KR) 10-2021-0021281

(51) Int. Cl. H05B 6/12

(52) U.S. Cl. CPC H05B 6/1218; H05B 2213/05; H05B 2213/07

(57) ABSTRACT

A cooking apparatus including a plate including a plurality of lighting lines and a knob area; a plurality of light-emitting elements configured to emit light through the plurality of lighting lines; a knob detachably attached to the knob area of the plate and configured to accept a command input; a display on the knob; a container sensor configured to detect a container positioned on an upper surface of the plate; a communication device configured to communicate with the knob; and a controller configured to set, based on container information obtained by the container sensor or a command input through the knob, a container area on the plate, control the plurality of light-emitting elements to emit light through at least one lighting line, among the plurality of lighting lines, positioned on an outer edge of the container area, and control the knob to display operational information about the container area.

### CROSS-REFERENCE TO RELATED APPLICATIONS

This application is a continuation application under 35 U.S.C. § 111(a) of international Application No. PCT/KR2022/001858, filed on Feb. 7, 2022, which claims priority to Korean Patent Application No. 10-2021-0021281, filed on Feb. 17, 2021, the disclosures of which are incorporated by reference herein in their entireties.

### BACKGROUND

### 1. Field

The present invention relates to a cooking apparatus capable of heating a container using an induction heating method, a method of controlling the cooking apparatus, and a knob capable of controlling the cooking apparatus.

### 2. Description of Related Art

A cooking apparatus is an apparatus for heating and cooking food. For example, cooking apparatuses may include gas ovens configured to burn gas to heat food, electric ovens configured to convert electrical energy into heat energy to heat food, microwave ranges configured to emit microwaves to food to heat food, gas ranges configured to burn gas to heat containers containing food, and induction heating apparatuses configured to generate magnetic fields to heat containers containing food.

Among such various cooking apparatuses, the induction heating apparatus has advantages that it is easy to control and safe and does not emit harmful gases because electricity is used as an energy source. In addition, the induction heating apparatus has advantages of supporting various functions for cooking food and high energy efficiency.

In general, in the case of a cooking apparatus using gas, a user ignites a fire zone using a dial-shaped knob separately provided for each fire zone and adjusts an intensity of fire. In addition, in the case of the conventional induction heating apparatus, a user operates a heating coil using an analog button or a touch button provided on a plate. In addition, the conventional induction heating apparatus provides a mark or a light-emitting diode (LED) on the plate to indicate a position of the heating coil.

However, an input device provided on the conventional cooking apparatus is difficult to satisfy a user's desire for a design of the cooking apparatus and has a limitation of not providing various operation methods. In addition, the LED provided on an upper plate of the conventional cooking apparatus does not properly display a size/type of container or an operating state of the cooking apparatus.

### SUMMARY

Aspects of embodiments of the disclosure will be set forth in part in the description which follows and, in part, will be apparent from the description, or may be learned by practice of the presented embodiments.

According to an embodiment of the disclosure, a cooking apparatus includes a plate including a plurality of lighting lines and a knob area; a plurality of light-emitting elements configured to emit light through the plurality of lighting lines; a knob detachably attached to the knob area of the plate and configured to accept a command input; a display on the knob; a container sensor configured to detect a container positioned on an upper surface of the plate; a communication device configured to communicate with the knob; and a controller configured to set, based on container information obtained by the container sensor or a command input through the knob, a container area on the plate, control the plurality of light-emitting elements to emit light through at least one lighting line, among the plurality of lighting lines, positioned on an outer edge of the container area, and control the knob to display operational information about the container area.

According to an embodiment of the disclosure, the controller sets the container area based on a size and a position of the container detected by the container sensor and included in the container information, or sets the container area based on a heating zone set command input through the knob.

According to an embodiment of the disclosure, the controller determines a type of the container based on the container information, and controls the plurality of light-emitting elements to emit light with a predetermined pattern through the at least one lighting line based on the type of the container being unusable.

According to an embodiment of the disclosure, the controller determines a position error of the container based on the container information, and controls the plurality of light-emitting elements to emit light with a pattern indicating the position error of the container through the at least one lighting line.

According to an embodiment of the disclosure, the cooking apparatus further includes a temperature sensor configured to detect a temperature of the plate, wherein, after cooking is completed in the container area of the plate, the controller controls the plurality of light-emitting elements to emit light with a pattern indicating residual heat of the container area through the at least one lighting line, and controls the knob to output a notification message about the residual heat of the container area.

According to an embodiment of the disclosure, the cooking apparatus further includes a plurality of heating coils arranged between the plurality of lighting lines under the plate, wherein the controller controls at least one heating coil among the plurality of heating coils, positioned in the container area, based on the command input through the knob.

According to an embodiment of the disclosure, the cooking apparatus further includes a container temperature sensor configured to detect a temperature of the container, wherein the controller sets a target temperature of the container area based on the command input through the knob, and controls the knob to output a notification message based on the temperature of the container reaching the target temperature.

According to an embodiment of the disclosure, the knob includes a temperature set button, and a control wheel configured to be rotatable; and the controller performs a temperature set mode for a cooking temperature of the container area based on a touch input to the temperature set button, and controls a manual set mode or auto set mode to be switched for the cooking temperature of the container area based on rotation of the control wheel.

According to an embodiment of the disclosure, the controller adjusts the target temperature based on the rotation of the control wheel in the manual set mode, and controls the knob to display a cooking menu based on the rotation of the control wheel in the auto set mode.

According to an embodiment of the disclosure, the knob includes a timer button, and a control wheel configured to be rotatable; and the controller performs a time set mode for a cooking time of the container area based on a touch input to the timer button, and adjusts the cooking time of the container area based on rotation of the control wheel.

According to an embodiment of the disclosure, the display of the knob is configured to receive a touch input, and upon setting a plurality of container areas, the controller determines a container area among the plurality of container areas to be a control target based on a heating zone selection command input through the display of the knob.

According to an embodiment of the disclosure, the controller stops an operation of a selected container area based on the touch input corresponding to the heating zone selection command being maintained for a predetermined time.

According to an embodiment of the disclosure, the knob further includes a housing, and a lighting module provided in the housing and configured to emit light through a lower surface of the housing upon the knob being attached to the knob area.

According to an embodiment of the disclosure, a method of controlling a cooking apparatus includes supplying wireless power to a knob attached to a knob area of a plate, the knob including a display; detecting a container positioned on an upper surface of the plate to obtain container information; setting a container area based on the container information or a command input through the knob; controlling a plurality of light-emitting elements to emit light through at least one lighting line among a plurality of lighting lines provided on the plate, the at least one lighting line being positioned on an outer edge of the container area; and displaying operational information about the container area on the knob.

According to an embodiment of the disclosure, the setting of the container area includes setting the container area based on a size and a position of the container included in the container information, or setting the container area based on a heating zone set command input through the knob.

### BRIEF DESCRIPTION OF THE DRAWINGS

These and/or other embodiments of the disclosure will become apparent and more readily appreciated from the following description of the embodiments, taken in conjunction with the accompanying drawings of which:

FIG. 1 is a view illustrating a cooking apparatus including a knob according to an embodiment of the disclosure.

FIG. 2 is a view illustrating a layout of lighting lines and heating coils provided on a plate of the cooking apparatus according to an embodiment of the disclosure.

FIG. 3 is a control block diagram of a cooking apparatus according to an embodiment of the disclosure.

FIG. 4 is a cross-sectional view illustrating the knob and the cooking apparatus according to according to an embodiment of the disclosure.

FIG. 5 is a top plan view illustrating the knob according to according to an embodiment of the disclosure.

FIG. 6 is a bottom plan view illustrating the knob according to according to an embodiment of the disclosure.

FIG. 7 is a control block diagram of the knob according to according to an embodiment of the disclosure.

FIG. 8 is a view illustrating an example of an operation of the lighting lines of the plate and the knob when the knob is attached according to an embodiment of the disclosure.

FIG. 9 is a view illustrating an example of container area setting when a container is disposed and heating power adjustment is performed by the knob according to an embodiment of the disclosure.

FIG. 10 is a view illustrating an example of a container area and lighting lines determined according to a size of a container and an operation of the knob according to an embodiment of the disclosure.

FIG. 11 is a view illustrating an example of light-emission of the lighting lines for an unusable type container according to an embodiment of the disclosure.

FIG. 12 is a view illustrating an example of light-emission of the lighting lines for a position error of a container according to an embodiment of the disclosure.

FIG. 13 is a view illustrating an example of light-emission of the lighting lines when residual heat is detected in a container area after cooking is completed according to an embodiment of the disclosure.

FIG. 14 is a view illustrating an example of heating power adjustment for specific container areas when a plurality of container areas are set according to an embodiment of the disclosure.

FIG. 15 is a view illustrating an example in which an automatic setting or a manual setting for a cooking temperature of a container area is switched by the knob according to an embodiment of the disclosure.

FIG. 16 is a view illustrating an example in which a cooking temperature of a container area is automatically set by the knob according to an embodiment of the disclosure.

FIG. 17 is a view illustrating an example in which a cooking temperature of a container area is manually set by the knob according to an embodiment of the disclosure.

FIG. 18 is a view illustrating an example in which a cooking time of a container area is adjusted by the knob according to an embodiment of the disclosure.

FIG. 19 is a flowchart for describing a method of controlling the cooking apparatus according to according to an embodiment of the disclosure.

### DETAILED DESCRIPTION

Like reference numerals denote like elements throughout the specification. In the present specification, all elements of embodiments are not described, and general contents in the art or repeated contents between the embodiments will not be described. Terms such as “parts, modules, members, and blocks” can be implemented using software or hardware, and a plurality of parts, modules, members, and blocks are implemented as a single element, or one part, module, member, or block may also include a plurality of elements.

Throughout the specification, when one part is referred to as being “connected” to the other part, it includes “directly connected” to the other part and “indirectly connected” to the other part, and the “indirectly connected” to the other part includes “connected” to the other part through a wireless communication network or “electrically connected” through an electric wire.

In addition, the terminology used in the specification is for the purpose of describing embodiments only and does not limit the present invention. The singular forms are intended to include the plural forms, unless the context clearly indicates otherwise. In the present specification, terms such as “comprise,” “including,” or the like are used to specify the presence of stated features, numbers, steps, operations, elements, components, or combinations thereof but do not preclude the presence or addition of one or more other features, numbers, steps, operations, elements, components, or combinations thereof.

In addition, terms including ordinal numbers such as “first,” “second,” and the like used in the specification are used distinguish a plurality of components from each other and do not specify an arrangement order, a manufacturing order, importance, or the like. The term “and/or” includes any and all combinations of one or more of the associated listed items. Hereinafter, embodiments of the disclosed invention will be described in detail.

Embodiments of the disclosure may provide a cooking apparatus capable of providing information about a position of a container and an operating state of the cooking apparatus using a lighting line provided on a plate and a knob detachably attached to the cooking apparatus, a method of controlling the cooking apparatus, and the knob capable of controlling the cooking apparatus.

According to example embodiments of the disclosure, a cooking apparatus, a method of controlling the cooking apparatus, and a knob capable of controlling the cooking apparatus may provide information about a position of a container and an operating state of the cooking apparatus using a lighting line provided on a plate and a knob detachably attached to the cooking apparatus. Accordingly, a user can intuitively check the operating state of the cooking apparatus.

In addition, example embodiments of a disclosed cooking apparatus, a control method of the cooking apparatus, and a knob capable of controlling the cooking apparatus may improve an aesthetic effect by removing or minimizing input/output interfaces other than a lighting line provided on a plate and a knob.

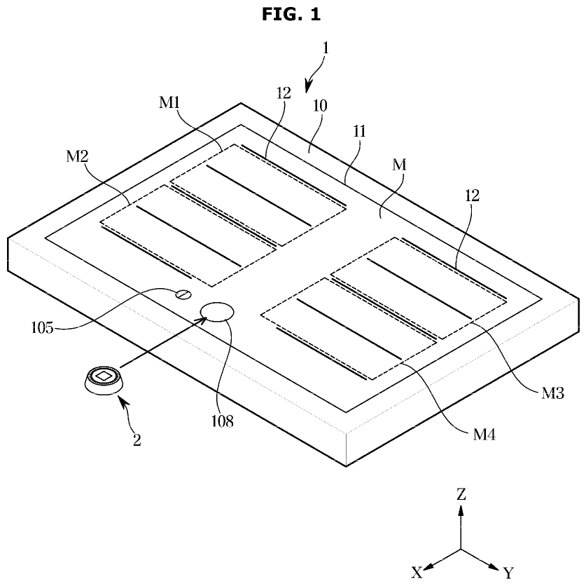

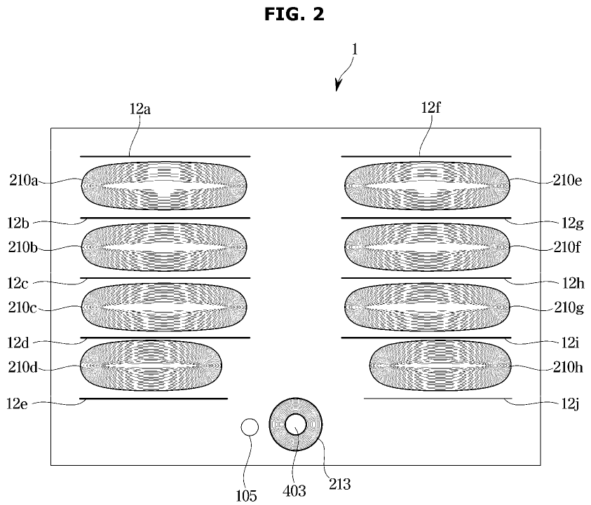

FIG. 1 is a view illustrating a cooking apparatus including a knob according to one embodiment. FIG. 2 is a view illustrating a layout of lighting lines and heating coils provided on a plate of the cooking apparatus.

Referring to FIGS. 1 and 2, a cooking apparatus 1 may be an induction heating apparatus. The cooking apparatus 1 may include a main body 10 which forms an exterior and in which various components are installed. A plate 11 on which a container may be disposed may be provided on an upper surface of the main body 10. The plate 11 may be formed of various materials. For example, the plate 11 may be formed of a tempered glass such as a ceramic glass.

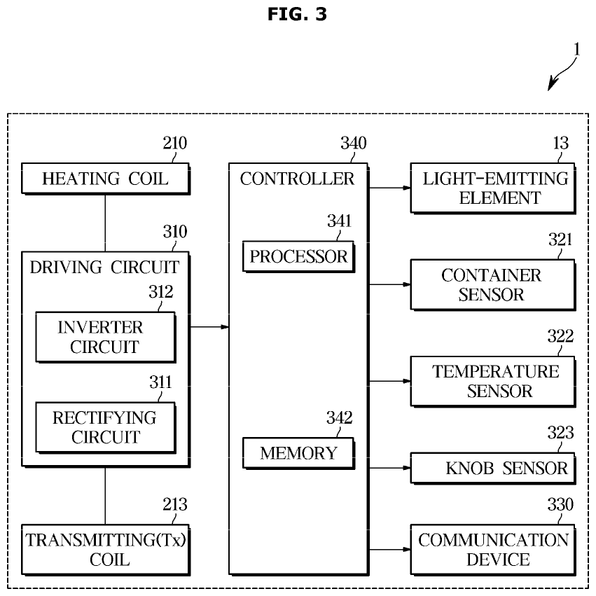

A plurality of lighting lines 12 (12a, 12b, 12c, 12d, 12e, 12f, 12g, 12h, 12i, and 12j) may be provided on the plate 11. In FIG. 1, an example of the lighting lines 12 including five lighting lines 12 provided on each of a left surface and a right surface is illustrated. Each of the lighting lines 12 of the plate 11 may be formed as a transparent member. A plurality of light-emitting elements 13 (FIG. 3) may form the lighting lines 12. The plurality of light-emitting elements 13 may be disposed under or in the lighting lines 12, and light may be emitted through the lighting lines 12 according to an operation of the light-emitting elements 13. The plurality of light-emitting elements 13 may operate individually according to control of a controller 340 (FIG. 3). Accordingly, light with various patterns may be emitted through the lighting lines 12. In addition, the light-emitting elements 13 may emit light with various colors.

Although an example of the lighting lines 12 being formed in a horizontal direction (Y direction) of the plate 11 is illustrated, the lighting lines 12 may also be formed in a vertical direction (X direction) of the plate 11. In addition, the lighting lines 12 may be formed in various patterns on the plate 11. Lengths of the lighting lines 12 may also be variously formed.

A plurality of heating coils 210 (210a, 210b, 210c, 210d, 210e, 210f, 210g, and 210h) may be provided under the plate 11. The heating coils 210 may be positioned between the plurality of lighting lines 12. For example, an example in which each elliptical heating coil 210 is disposed between the lighting lines 12 is illustrated in FIG. 2. In other words, a first heating coil 210a may be positioned between a first lighting line 12a and a second lighting line 12b. The heating coils 210 positioned between the lighting lines 12 may be referred to as the first heating coil 210a, a second heating coil 210b, a third heating coil 210c, a fourth heating coil 210d, a fifth heating coil 210e, a sixth heating coil 210f, a seventh heating coil 210g, and an eighth heating coil 210h.

Alternatively, the plurality of heating coils 210 may be disposed between the first lighting line 12a and the second lighting line 12b. The heating coils 210 may generate magnetic fields and/or electromagnetic fields based on a current applied from a driving circuit 310. Due to the magnetic fields generated by the heating coils 210, containers positioned on the plate 11 may be heated.

Container areas M (M1, M2, M3, and M4) may be set on the basis of container information obtained by container sensors or a command input through a knob 2. One or more container areas M may be set. In addition, sizes and/or the number of container areas M may vary based on positions of containers or a heating zone set command input through the knob 2. The container areas M may be set to correspond to positions of the heating coils 210. For example, as illustrated in FIG. 1, the number of the container areas M (M1, M2, M3, and M4) may be set to four. The first heating coil 210a and the second heating coil 210b included in one container area (for example, a first container area M1) may be controlled at the same time. In addition, the heating coils 210 included in the different container areas M may operate individually.

When one of the container areas M is set, light may be emitted through at least one lighting line corresponding to the container area M among the plurality of lighting lines 12. Specifically, light may be emitted through at least one lighting line positioned on an outer edge of the container area among the plurality of lighting lines. For example, when the first container area M1 is set, light may be emitted through the lighting lines 12a and 12c positioned on an edge of the first container area M1. That is, the light may be emitted through the lighting lines 12a and 12c positioned at an upper end and a lower end of the first container area M1.

A power button 105 and a knob area 108 may be provided on the plate 11. The power button 105 may receive a power-on input or a power-off input. When a touch input to the power button 105 is received while a power source of the cooking apparatus 1 has been turned off, the power source of the cooking apparatus 1 may be turned on. Conversely, when a touch input to the power button 105 is received while the power source of the cooking apparatus 1 has been turned on, the power source of the cooking apparatus 1 may be turned off.

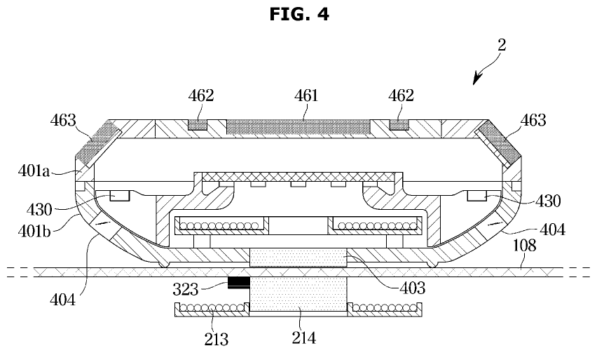

The knob 2 may be detachably attached to the knob area 108. When the knob 2 is attached to the knob area 108, the knob 2 may receive wireless power from a transmitting (Tx) coil 213 provided under the knob area 108. A magnet 403 may be provided on a lower surface of the knob 2, and a magnet 214 (FIG. 4) may also be provided under the knob area 108. The magnet 403 of the knob 2 may be referred to as a first magnet, and the magnet 214 of the knob area 108 may be referred to as a second magnet. When the knob 2 is positioned in the knob area 108, the knob 2 may be attached to the knob area 108 by an attraction between the first magnet 403 and the second magnet 214. The knob 2 may serve as an input device for controlling an operation of the cooking apparatus 1 and/or an output device for outputting information about an operating state of the cooking apparatus 1.

FIG. 3 is a control block diagram of a cooking apparatus.

Referring to FIG. 3, the cooking apparatus 1 according to one embodiment may include the light-emitting elements 13, the heating coils 210, the Tx coil 213, the driving circuit 310, container sensors 321, temperature sensors 322, a knob sensor 323, a communication device 330, and the controller 340. The controller 340 may be electrically connected to components of the cooking apparatus 1 and may control an operation of each of the components. The controller 340 may include a control circuit. A printed circuit board may be provided in the main body 10. The light-emitting element 13, the driving circuit 310, each of the container sensors 321, each of the temperature sensors 322, the communication device 330, and the controller 340 may be installed on one printed circuit board or divided and installed on a plurality of printed circuit boards.

The plurality of light-emitting elements 13 may form the lighting lines 12. The plurality of light-emitting elements 13 may be disposed under or in each of the lighting lines 12 provided on the plate 11. According to an operation of the light-emitting elements 13, light may be emitted through the lighting lines 12 of the plate 11. The controller 340 may control each of the plurality of light-emitting elements 13. Accordingly, the plurality of light-emitting elements 13 may emit light with various patterns. For example, the plurality of light-emitting elements 13 may be turned on or off at the same time. Some of the plurality of light-emitting elements 13 may be turned on and the rest may be turned off. The plurality of light-emitting elements 13 included in one lighting line 12 may realize a visual effect (for example, an animation effect) in which the lighting line 12 becomes gradually longer or shorter when the plurality of light-emitting elements 13 sequentially emit light. In addition, the light-emitting elements 13 may emit light with various colors, and an intensity of light emitted by each of the light-emitting elements 13 may also be adjusted.

The heating coils 210 may be provided under the plate 11 of the cooking apparatus 1. The heating coil 210 may generate a magnetic field and/or an electromagnetic field based on a current applied from the driving circuit 310. Due to the magnetic field generated by the heating coil 210, a container positioned on the plate 11 may be heated.

The Tx coil 213 may be provided under the knob area 108 of the plate 11. The Tx coil 213 may transmit wireless power to the knob 2. When the knob 2 is attached to the knob area 108, a receiving (Rx) coil 410 (FIG. 4) of the knob 2 is positioned above the Tx coil 213. The knob 2 may operate using power transmitted from the Tx coil 213 of the knob area 108 to the Rx coil 410.

The driving circuit 310 may apply a current to each of the heating coil 210 and the Tx coil 213. The driving circuit 310 may receive power from an external power source, rectify the power, and provide the rectified power to the heating coil 210, the Tx coil 213, and the controller 340. In addition, the controller 340 may distribute the power transmitted from the driving circuit 310 to the light-emitting elements 13, the container sensor 321, the temperature sensor 322, and the communication device 330. Alternatively, the driving circuit 310 may directly supply the rectified power to each of the light-emitting element 13, the heating coil 210, the Tx coil 213, the container sensor 321, the temperature sensor 322, the communication device 330, and the controller 340.

The driving circuit 310 may include a rectifying circuit 311 and an inverter circuit 312. The rectifying circuit 311 may convert alternating current (AC) power into direct current (DC) power. The rectifying circuit 311 may convert an AC voltage of which a magnitude and a polarity (a positive voltage or a negative voltage) change over time into a DC voltage of which a magnitude and a polarity are constant and convert an AC current of which an amount and a direction (a positive current or a negative current) change over time to a DC current of which an amount is constant.

The rectifying circuit 311 may include a bridge diode. For example, the rectifying circuit 311 may include four diodes. Two diodes may be connected in series to form a pair of diodes, and two pairs of diodes may be connected in parallel. The bridge diode may convert an AC voltage of which a polarity changes over time to a positive voltage of which a polarity is fixed and convert an AC current of which a direction changes over time into a positive current of which a direction is fixed.

In addition, the rectifying circuit 311 may include a DC link capacitor. The DC link capacitor may convert a positive voltage of which a magnitude changes over time to a DC voltage of which a magnitude is constant. The DC link capacitor may maintain the converted DC voltage and provide the converted DC voltage to the inverter circuit 312.

The inverter circuit 312 allows a current to flow to each of the heating coil 210 and the Tx coil 213 by switching a voltage applied to each of the heating coil 210 and the Tx coil 213. The inverter circuit 312 may include a switching circuit and a resonant capacitor which supply a current to each of the heating coil 210 and the Tx coil 213 or blocks a current. The switching circuit may include at least one switch element. One end of each of the heating coil 210 and the Tx coil 213 is connected to a connection point of the switch element, and the other end of each of the heating coil 210 and the Tx coil 213 may be connected to the resonant capacitor. The switch element may be turned on or off according to a control signal of the controller 340. Due to the switching operation (on/off) of the switch element, a current and a voltage may be applied to each of the heating coil 210 and the Tx coil 213.

The resonant capacitor serves as a shock absorber. The resonant capacitor adjusts a saturation voltage rise rate while the switch element is turned off and affects energy loss. In addition, the resonant capacitor determines a resonant frequency of each of the heating coil 210 and the Tx coil 213. Since the switch element is turned on or off at high speed, the switch element may be implemented as a three-terminal semiconductor device switch with a fast response speed. For example, the switch element may be a bipolar junction transistor (BJT), a metal-oxide-semiconductor field effect transistor (MOSFET), an insulated gate bipolar transistor (IGBT), or a thyristor.

Each of the heating coil 210 and the Tx coil 213 generate a magnetic field using a current applied from the inverter circuit 312. A container positioned on the plate 11 may be heated by the magnetic field generated by the heating coil 210. In addition, a current and a voltage may be applied to the Rx coil 410 of the knob 2 by the magnetic field generated by the Tx coil 213.

The container sensor 321 may detect a container disposed on the plate 11. The container sensor 321 may detect at least one of a size, a position, and a type of a container disposed on the plate 11. The container sensor 321 may include a capacitive sensor capable of detecting a change in capacitance due to a container. In addition, the container sensor 321 may include at least one of an infrared sensor, a micro switch, and a membrane switch. In addition, the container sensor 321 may also include various sensors.

The container sensor 321 may obtain container information including at least one of a size, a position, and a type of a container and may transmit the container information to the controller 340. The controller 340 may determine at least one heating coil 210 positioned under a container among the plurality of heating coils 210. The controller 340 may set the container area M (M1, M2, M3, M4, or Mf) of the plate 11 on the basis of the container information and control the plurality of light-emitting elements 13 to emit light through at least one lighting line 12 corresponding to the container area M. For example, light may be emitted through at least one lighting line positioned at an outer edge of a container area among the plurality of lighting lines.

Meanwhile, the container sensor 321 may be omitted in the cooking apparatus 1. In this case, the controller 340 may serve as a container sensor 321. The controller 340 may detect at least one of a position, a size, and a type of a container on the basis of an inductance of the heating coil 210 changed by a container disposed on the plate 11. The inductance of the heating coil 210 measured when the container is disposed above the heating coil 210 is different from an inductance of the heating coil 210 measured when the container is not present above the heating coil 210. The controller 340 may control the driving circuit 310 to apply a detection current for detecting the container to the heating coil 210. In addition, a container may be detected through various methods.

The temperature sensor 322 may measure at least one of a temperature of the heating coil 210, a temperature of the plate 11, and a temperature in the main body 10. The temperature sensor 322 may include at least one of a thermistor of which an electrical resistance value changes according to a temperature, an infrared sensor, and a color sensor. The temperature sensor 322 may transmit temperature data to the controller 340. The controller 340 may determine whether the heating coil 210 is overheated on the basis of the temperature data. In addition, the controller 340 may control the plurality of light-emitting elements 13 to emit light indicating residual heat of the plate 11 through at least one lighting line 12 on the basis of the temperature data after cooking is completed. In addition, the controller 340 may control the knob 2 to output a notification message about the residual heat of the plate 11.

The container sensor 321 and the temperature sensor 322 may be positioned at a center of the heating coil 210 or around the heating coil 210. In addition, the container sensor 321 and the temperature sensor 322 may be installed at various positions of the cooking apparatus 1. In addition, the cooking apparatus 1 may include various sensors. For example, the cooking apparatus 1 may further include weight sensors.

The knob sensor 323 may detect whether the knob 2 is attached or separated. The knob sensor 323 may be positioned near the second magnet 214 provided under the knob area 108 of the cooking apparatus 1. The knob sensor 323 may transmit knob detection information to the controller 340. The controller 340 may control the Tx coil 213 positioned under the knob area 108 to be driven on the basis of the knob detection information. The knob sensor 323 may be implemented as a magnetic sensor (for example, a Hall sensor).

The communication device 330 may communicate with the knob 2. The communication device 330 may be implemented using various wireless communication technologies. For example, at least one of radio frequency (RF), infrared communication, Wi-Fi, Bluetooth, ZigBee, and near field communication (NFC) may be applied to the communication device 330. The communication device 330 may be an NFC module. The communication device 330 of the cooking apparatus 1 may be referred to as a “first communication device.”

The controller 340 may include a processor 341 and a memory 342. The memory 342 may store programs, instructions, and data for controlling an operation of the cooking apparatus 1. The processor 341 may generate a control signal to control the operation of the cooking apparatus 1 on the basis the programs, instructions, and data stored in the memory 342. The controller 340 may be implemented as a control circuit on which the processor 341 and the memory 342 are mounted. In addition, the controller 340 may include a plurality of processors and a plurality of memories. The controller 340 of the cooking apparatus 1 may be referred to as a “first controller.”

The processor 341 is hardware and may include a logic circuit and an arithmetic circuit. The processor 341 may process data according to the programs and/or instructions provided from the memory 342 and generate a control signal according to a process result. The memory 342 may include a volatile memory such as a static random access memory (SRAM) or a dynamic random access memory (DRAM) for temporarily storing data and a nonvolatile memory such as a read only memory (ROM), an erasable programmable read only memory (EPROM), or an electrically erasable programmable read only memory (EEPROM) for storing data for a long time.

Some of the above-described components may be omitted in the cooking apparatus 1. In addition, the cooking apparatus 1 may also further include other components in addition to those described above. For example, the cooking apparatus 1 may further include a speaker.

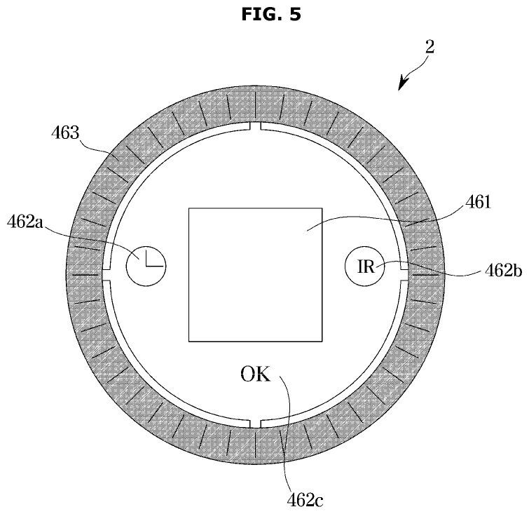

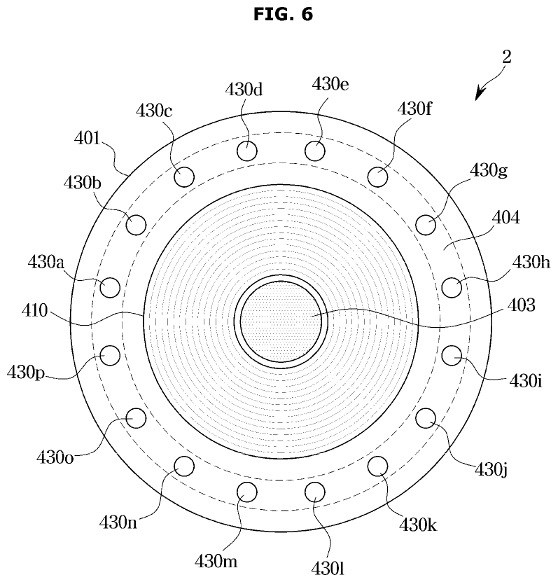

FIG. 4 is a cross-sectional view illustrating the knob and the cooking apparatus according to one embodiment. FIG. 5 is a top plan view illustrating the knob according to one embodiment. FIG. 6 is a bottom plan view illustrating the knob according to one embodiment.

Referring to FIG. 4, the knob 2 may include a housing 401, a circuit board 402 provided in the housing 401, the first magnet 403 provided on a lower surface of the housing 401, the Rx coil 410 configured to receive wireless power from the Tx coil 213 of the cooking apparatus 1, a lighting module 430 configured to emit light through the lower surface of the housing 401, a display 461, a button 462, and a control wheel 463.

In FIG. 4, a cross section of the cooking apparatus 1 is simply illustrated as a partial cross section of the knob area 108. The cooking apparatus 1 may include the knob area 108 of the plate 11, the Tx coil 213 provided under the knob area 108, the second magnet 214 positioned in a center of the Tx coil 213 under the knob area 108, and the knob sensor 323 configured to detect attachment or separation of the knob 2. The knob sensor 323 may be positioned near the second magnet 214.

Each of the first magnet 403 of the knob 2 and the second magnet 214 of the cooking apparatus 1 may include an N pole and an S pole. In addition, the second magnet 214 of the cooking apparatus 1 may be a ferromagnetic material in which magnetic moments are arranged. For example, the second magnet 214 may be a permanent magnet.

The housing 401 of the knob 2 may include an upper housing 401a and a lower housing 401b. The upper housing 401a and the lower housing 401b may be coupled to form the entire housing 401. Alternatively, the upper housing 401a and the lower housing 401b are not divided, and one housing 401 may be formed. A planar shape of the housing 401 viewed from above may be a circular shape, and a cross-sectional shape of the housing 401 viewed from the side may be a polygonal shape. In addition, the lower surface of the housing 401 may be flat and may include a hole through which a part of the first magnet 403 is exposed to the outside. The housing 401 may have a shape different from the illustrated shape.

The display 461, the button 462, and the control wheel 463 may be provided on the upper housing 401a. The display 461, the button 462, and the control wheel 463 are included in a user interface 460 for inputting a command for an operation of the cooking apparatus 1 and outputting an operating state of the cooking apparatus 1.

A light transmitting window 404 may be proved in the lower housing 401b. The light transmitting window 404 may be provided along a perimeter of the lower housing 401b. The light transmitting window 404 may be provided as a transparent member or a translucent member. Accordingly, light generated by the lighting module 430 may be emitted to the outside through the light transmitting window 404. When the lower housing 401b includes the light transmitting window 404, the other portion of the lower housing 401b may be formed of an opaque material. Alternatively, the lower housing 401b may be formed of a transparent material or a translucent material. Accordingly, light of the lighting module 430 may be emitted to the outside through the lower housing 401b.

The first magnet 403 of the knob 2 may move with the housing 401. For example, when the housing 401 rotates, the first magnet 403 may also rotate with the housing 401. As the housing 401 and the first magnet 403 rotate together, a change in magnetic field between the first magnet 403 and the second magnet 214 of the cooking apparatus 1 may occur.

The circuit board 402 may be provided in the housing 401 and may include an electronic circuit for driving the knob 2. A power conversion circuit 420, a communication device 440, and a controller 470 may be provided on the circuit board 402. In addition, the circuit board 402 may be electrically connected to the Rx coil 410, the lighting module 430, the display 461, the button 462, and the control wheel 463.

The Rx coil 410 may receive power from the Tx coil 213 of the cooking apparatus 1. When the knob 2 is disposed in the knob area 108 of the cooking apparatus 1, the Rx coil 410 receives wireless power due to electromagnetic induction. The magnet 403 of the knob 2 may be positioned at the center of the Rx coil 410. The Rx coil 410 may be positioned above the magnet 403. Alternatively, when a size of the magnet 403 is smaller than a size of a hole formed in the center of the Rx coil 410, the magnet 403 may be provided to pass through the center of the Rx coil 410.

Referring to FIG. 5, the knob 2 may include the display 461, the button 462, and the control wheel 463. The display 461 may be provided on an upper surface of housing 401 and may include a touch panel and/or a touch screen. In addition, the display 461 may be implemented as a liquid crystal display (LCD), a light-emitting diode (LED), or an organic light-emitting diode (OLED).

The display 461 may display an operating state of the cooking apparatus 1 and may receive a user's touch input. For example, the display 461 may display heating power of the container area M in which cooking is being performed. The heating power may be displayed as a number indicating a heating step or temperature. In addition, the display 461 may display a cooking time of the container area M. The cooking time may be displayed in units of hours, minutes and/or seconds. The display 461 may receive a touch input for selecting a container area which is a control target among the plurality of container areas.

The button 462 may be provided around the display 461 and may be implemented as a touch button or a physical button. For example, the button 462 may include one or more of a timer button 462a and a temperature set button 462b and may further include a confirmation button 462c. The controller 340 of the cooking apparatus 1 may perform a time set mode for a cooking time of the container area M on the basis of a touch input performed using the timer button 462a of the knob 2. In addition, the controller 340 may perform a temperature set mode for a cooking temperature of the container area M on the basis of a touch input performed using the temperature set button 462b of the knob 2. According to an operating state of the cooking apparatus 1 and the knob 2, the button 462 may be activated or deactivated. The button 462 may include a backlight, and when the button 462 is activated, the button 462 may emit light using the backlight.

The control wheel 463 may be provided in a circular ring shape on an edge of an upper surface of the housing 401. The control wheel 463 may rotate left or right according to a manipulation of the user. The controller 470 of the cooking apparatus 1 may adjust heating power of the container area M on the basis of rotation of the control wheel 463, set a target temperature of the container area M, and adjust a cooking time of the container area M. When the controller 470 of the cooking apparatus 1 performs the temperature set mode, a manual set mode or auto set mode may be switched for a cooking temperature of the container area M on the basis of rotation of the control wheel 463. In addition, the controller 470 of the cooking apparatus 1 may search for a cooking menu on the basis of rotation of the control wheel 463 in the auto set mode for the cooking temperature of the container area M.

The cooking apparatus 1 may set the container area M of the plate 11 on the basis of a command input through the knob 2 and may drive at least one heating coil 210 corresponding to the set container area M. When the plurality of container areas M are set, the user may select the container areas M which are a control target by manipulating the knob 2 attached to the knob area 108, and adjust heating power of at least one heating coil 210 included in the selected container areas M.

Referring to FIG. 6, a plurality of light-emitting elements 430a, 430b, 430c, 430d, 430e, 430f, 430g, 430h, 430i, 430j, 430k, 430l, 430m, 430n, 430o, and 430p included in the lighting module 430 may be disposed to form a circle at equal intervals. The plurality of light-emitting elements may be positioned between an inner surface of the housing 401 and the Rx coil 410. In other words, a first light-emitting element 430a, a second light-emitting element 430b, a third light-emitting element 430c, a fourth light-emitting element 430d, a fifth light-emitting element 430e, a sixth light-emitting element 430f, a seventh light-emitting element 430g, an eighth light-emitting element 430h, a ninth light-emitting element 430i, a tenth light-emitting element 430j, an eleventh light-emitting element 430k, a twelfth light-emitting element 430l, a thirteenth light-emitting element 430m, a fourteenth light-emitting element 430n, a fifteenth light-emitting element 430o, and a sixteenth light-emitting element 430p may be disposed to be spaced apart from each other to form the circle. In FIG. 5, an example of the lighting module 430 including sixteen light-emitting elements is illustrated, but a layout of the lighting module 430 may vary according to a design.

When a power source of the knob 2 is turned on, the lighting module 430 may be controlled to emit light. The lighting module 430 may emit light with various colors. A color of light emitted by the lighting module 430 may be determined according to an operation of the cooking apparatus 1 and the knob 2.

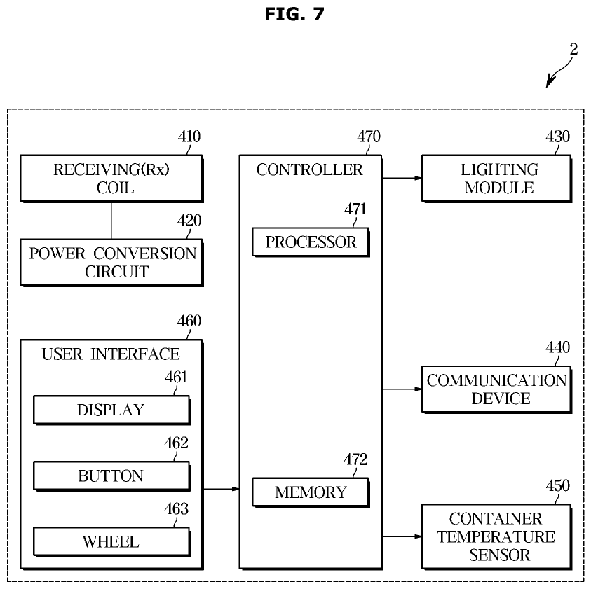

FIG. 7 is a control block diagram of the knob according to one embodiment.

Referring to FIG. 7, the knob 2 may include the Rx coil 410, the power conversion circuit 420, the lighting module 430, the communication device 440, the user interface 460, and the controller 470. In addition, the knob 2 may further include a container temperature sensor 450.

The Rx coil 410 and the power conversion circuit 420 may supply power to each of the lighting module 430, the communication device 440, the container temperature sensor 450, the user interface 460, and the controller 470. The controller 470 may also distribute power received from the power conversion circuit 420 to the lighting module 430, the communication device 440, the container temperature sensor 450, and the user interface 460.

The power conversion circuit 420 may include a rectifying circuit. An AC voltage and an AC current may be applied to the Rx coil 410 configured to receive power from the Tx coil 213 of the cooking apparatus 1. However, since the lighting module 430, the communication device 440, the container temperature sensor 450, and the controller 470 of the knob 2 require DC power, the power conversion circuit 420 is required. In addition, the power conversion circuit 420 may include a DC-DC converter for applying appropriate power to each component of the knob 2.

The communication device 440 may communicate with the cooking apparatus 1. The communication device 440 may be implemented as various wireless communication technologies. For example, at least one of RF, infrared communication, Wi-Fi, Bluetooth, ZigBee, and NFC may be applied to the communication device 440. Preferably, the communication device 440 may be an NFC module. The communication device 440 of the knob 2 may be referred to as a “second communication device.”

The container temperature sensor 450 may measure a temperature of a container disposed on the plate 11. The container temperature sensor 450 may obtain container temperature data and transmit the container temperature data to the cooking apparatus 1. The container temperature sensor 450 may include at least one of an infrared sensor and a color sensor. The container temperature sensor 450 may be provided in the cooking apparatus 1. The controller 340 of the cooking apparatus 1 may control an operation of the heating coil 210 on the basis of the container temperature data. For example, the cooking apparatus 1 may stop the operation of the heating coil 210 when a temperature of the container reaches a target temperature. In addition, the cooking apparatus 1 may control the knob 2 to output a notification message when a temperature of the container reaches the target temperature.

The user interface 460 may include the display 461, the button 462, and the control wheel 463. The user interface 460 may input a command for an operation of the cooking apparatus 1 and output an operating state of the cooking apparatus 1. The user interface 460 is the same as that described with respect to FIG. 5.

The controller 470 may include a processor 471 and a memory 472. The controller 470 is electrically connected to components of the knob 2 and may control each component. That is, the controller 470 may control the power conversion circuit 420, the lighting module 430, the communication device 440, and the container temperature sensor 450. The controller 470 of the knob 2 may be referred to as a “second controller.”

The controller 470 may determine receiving or blocking of wireless power on the basis of whether the first magnet 403 is attached to the second magnet 214 positioned in the knob area 108 of the cooking apparatus 1. In other words, when the first magnet 403 of the knob 2 is attached to the second magnet 214 of the cooking apparatus 1, the controller 470 may control the power conversion circuit 420 to distribute received wireless power. Conversely, when the first magnet 403 of the knob 2 is separated from the second magnet 214 of the cooking apparatus 1, the controller 470 may determine blocking of wireless power. In addition, when the knob 2 is separated from the plate 11, the controller 340 of the cooking apparatus 1 may turn off the power source of the cooking apparatus 1.

Some of the above-described components of the knob 2 may be omitted in the knob 2. In addition, the knob 2 may further include other components in addition to the above-described components. For example, the knob 2 may further include a speaker.

Hereinafter, an operation of the cooking apparatus 1 and the knob 2 according to one embodiment will be described in detail.

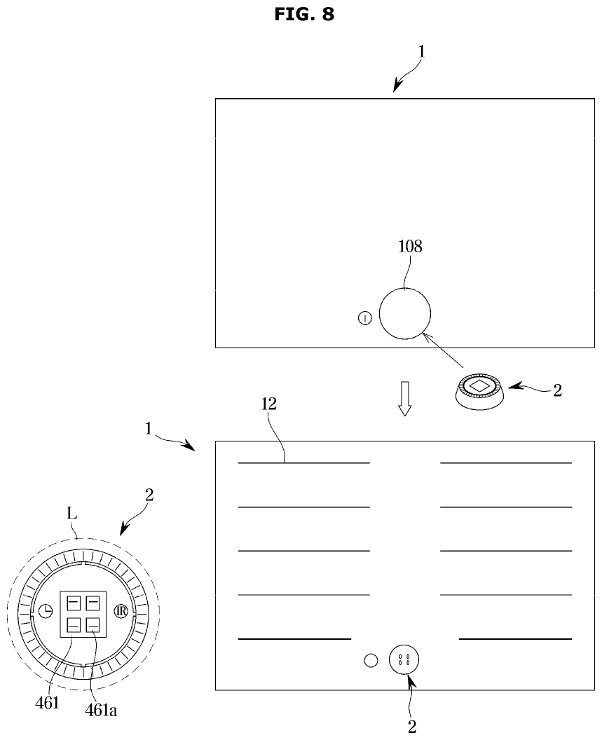

FIG. 8 is a view illustrating an example of an operation of the lighting lines of the plate and the knob when the knob is attached.

Referring to FIG. 8, the knob 2 may be attached to the knob area 108 of the plate 11. When the knob 2 is attached to the knob area 108, the power source of the cooking apparatus 1 may be turned on, and the knob 2 may receive wireless power from the cooking apparatus 1. After the knob 2 is attached, the power source of the cooking apparatus 1 may be turned on using the power button 105 of the cooking apparatus 1. In addition, the knob 2 may also be attached when the power source of the cooking apparatus 1 has been turned on.

When the knob 2 is attached to the knob area 108, and the power source of the cooking apparatus 1 is turned on, light may be emitted through the lighting line 12 of the plate 11. The controller 340 of the cooking apparatus 1 may control the plurality of light-emitting elements 13 positioned under or in the lighting line 12 to emit light on the basis of attachment of the knob 2. A pattern of light emitted through the lighting lines 12 to notify that the power source of the cooking apparatus 1 is turned on may be variously set. For example, all the light-emitting elements 13 of all lighting lines 12 may be controlled to emit light at the same time. That is, the light may be emitted through all ten lighting lines 12.

The knob 2 may output a greeting message indicating that the power source of the cooking apparatus 1 is turned on through the display 461. In addition, the lighting module 430 of the knob 2 may operate to emit light L from a lower portion of the knob 2. Then, the display 461 of the knob 2 may display a predetermined plurality of heating zone images 461a. Each of the heating zone images 461a may indicate the container area M. For example, an upper left heating zone image may indicate the first container area M1, a lower left heating zone image may indicate a second container area M2, an upper right heating zone image may indicate a third container area M3, and a lower right heating zone image may indicate a fourth container area M4. In addition, the heating zone image may be displayed to correspond to each heating coil 210. As another example, a number indicating heating power of the container area M may be displayed instead of the heating zone image.

Meanwhile, after the power source of the cooking apparatus 1 is turned on and the knob 2 is attached to the knob area 108, when a command through the knob 2 is not received for a predetermined time, the lighting line 12 of the cooking apparatus 1 may be turned off.

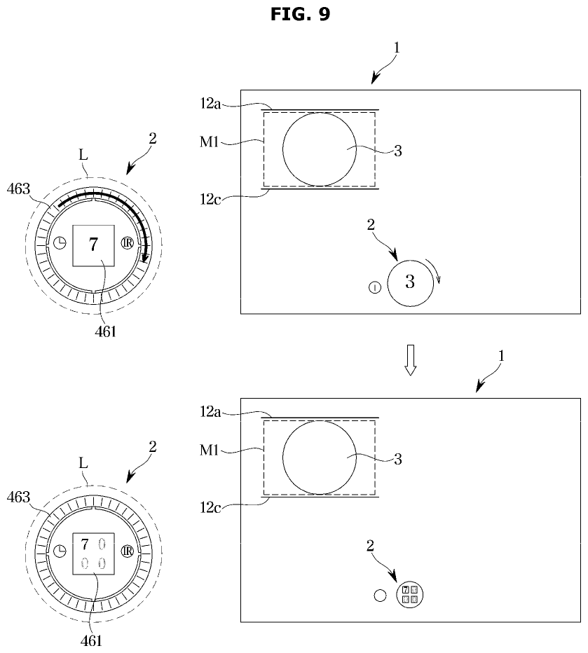

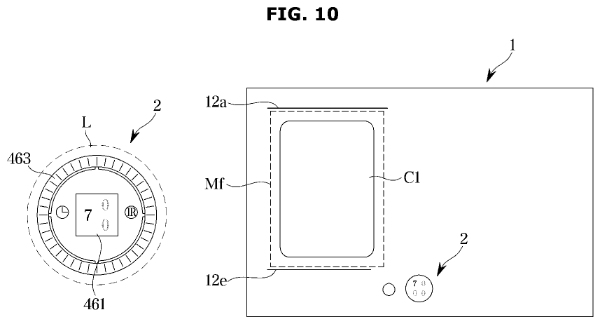

FIG. 9 is a view illustrating an example of container area setting when a container is disposed and heating power adjustment performed by the knob. FIG. 10 is a view illustrating an example of a container area and lighting lines determined according to a size of a container and an operation of the knob.

Referring to FIG. 9, the controller 340 of the cooking apparatus 1 may set the container area M of the plate 11 on the basis of container information obtained by the container sensor 321 or a command input through the knob 2. When a container 3 is disposed on the plate 11, the container sensor 321 may obtain container information including a size, a position, and a type of the container 3. The controller 340 sets the container area M on the basis of the size and the position of the container 3. The container area M may be set to correspond to a position of the heating coil 210. For example, as illustrated in FIG. 9, the first container area M1 may be set according to a position of the container 3. The first heating coil 210a and the second heating coil 210b may be positioned under the first container area M1. The first heating coil 210a and the second heating coil 210b included in the first container area M1 may be controlled at the same time.

In addition, the container area M may be set by the heating zone set command input through the knob 2. For example, when the user touches a heating zone image displayed at an upper left end on the display 461 of the knob 2, the first container area M1 may be set.

When the container area M is set, the controller 340 of the cooking apparatus 1 may control the light-emitting elements 13 to emit light through at least one lighting line corresponding to the container area M among the plurality of lighting lines 12. For example, light may be emitted through at least one lighting line positioned at an outer edge of the container area among the plurality of lighting lines. When the first container area M1 is set, light may be emitted through the lighting lines 12a and 12c positioned at the edge of the first container area M1. That is, the light may be emitted through the first lighting line 12a positioned on the upper end of the first container area M1 and from the third lighting line 12c positioned on the lower end of the first container area M1. The user may identify that the container 3 is properly disposed through the light emitted through the first lighting line 12a and the third lighting line 12c.

The controller 340 of the cooking apparatus 1 may control one or more heating coils 210a and 210b positioned in the container area among the plurality of heating coils 210 on the basis of a command input through the knob 2. For example, the user may rotate the control wheel 463 of the knob 2 to adjust heating power of the first container area M1. When the control wheel 463 rotates clockwise, the heating power may increase, and when the control wheel 463 rotates counterclockwise, the heating power may decrease.

The controller 340 of the cooking apparatus 1 may control the knob 2 to display operational information about a container area. The operational information about the container area may include heating power, a temperature, and/or a cooking time for the container area. For example, when the first container area M1 is set, the display 461 of the knob 2 may display a heating zone image or a number corresponding to the first container area M1. In addition, the display 461 of the knob 2 may display heating power of the first container area M1. The heating power may be displayed using a number indicating a heating step or temperature. The heating step may indicate, for example, from a step 0 to a step 9. The step 0 may indicate that an operation of the heating coil 210 corresponding to the container area M is stopped.

Referring to FIG. 10, a container C1 may be disposed at a position overlapping the first heating coil 210a, the second heating coil 210b, the third heating coil 210c, and the fourth heating coil 210d on the plate 11. In this case, the controller 340 of the cooking apparatus 1 may set a fifth container area MF including the first heating coil 210a, the second heating coil 210b, the third heating coil 210c, and the fourth heating coil 210d on the basis of container information obtained from the container sensor 321.

The fifth container area Mf may be set by the heating zone set command input through the knob 2. For example, when a touch input for the upper left and lower left heating zone images displayed on the display 461 of the knob 2 is received at the same time, the fifth container area Mf may be set. The display 461 of the knob 2 may display a heating zone image or a number indicating the fifth container area Mf. For example, the upper left and lower left heating zone images displayed on the display 461 may disappear, and one heating zone image or a number indicating the fifth container area Mf may be displayed.

As described above, a container area may be flexibly set according to a size of a container or the heating zone set command, and the set container area may be displayed using the lighting line 12, and thus convenience of the user can be improved.

The controller 340 of the cooking apparatus 1 may control the light-emitting elements 13 to emit light through one or more lighting lines 12a and 12e corresponding to the fifth container area Mf among the plurality of lighting lines 12. For example, light may be emitted through the first lighting line 12a and a fifth lighting line 12e positioned at an upper end and a lower end of the fifth container area Mf.

Meanwhile, even when the container C1 is not disposed, the fifth container area Mf may be set by the heating zone set command input through the knob 2. However, when the container C1 is not disposed within a predetermined time or a heating power adjustment command is not input through the control wheel 463, the setting of the fifth container area Mf may be canceled.

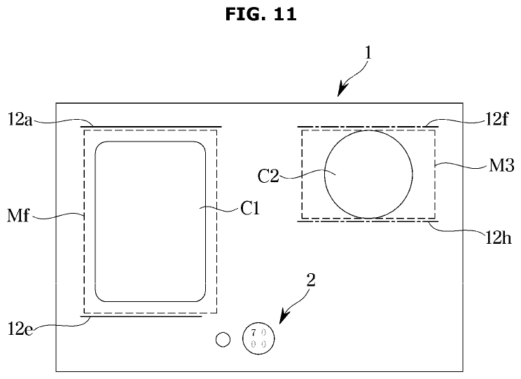

FIG. 11 is a view illustrating an example of light-emission of the lighting lines for an unusable type container.

Referring to FIG. 11, the first container C1 and a second container C2 may be disposed on the plate 11. The first container C1 may be disposed at a position overlapping the first heating coil 210a, the second heating coil 210b, the third heating coil 210c, and the fourth heating coil 210d. The second container C2 may be disposed at a position overlapping the fifth heating coil 210e and the sixth heating coil 210f The controller 340 of the cooking apparatus 1 may set the fifth container area Mf corresponding to a size and a position of the first container C1 and the third container area M3 corresponding to a size and a position of the second container C2 on the basis of container information obtained by the container sensor 321 or a command input through the knob 2. The third container area M3 may include the fifth heating coil 210e and the sixth heating coil 210f.

In addition, the controller 340 of the cooking apparatus 1 may control the light-emitting elements 13 to emit light through the first lighting line 12a and the fifth lighting line 12e corresponding to the fifth container area Mf and control the light-emitting elements 13 to emit light through the sixth lighting line 12f and an eighth lighting line 12h corresponding to the third container area M3.

The controller 340 may control the plurality of light-emitting elements 13 to emit light with a predetermined first pattern through at least one lighting line on the basis of a type of an unusable container. The controller 340 may determine a type of container on the basis of container information. For example, types of containers such as a glass container, a porcelain container, and an aluminum container cannot be used in an induction heating apparatus.

When the first container C1 is a stainless steel container, and the second container C2 is a glass container, the controller 340 may determine that the second container C2 is a type of container which cannot be used in the cooking apparatus 1. The controller 340 may control the light-emitting elements 13 to emit light with the first pattern through the sixth lighting line 12f and the eighth lighting line 12h corresponding to the third container area M3 in which the second container C2 is positioned. For example, the first pattern may be a blinking dotted line. That is, the sixth lighting line 12f and the eighth lighting line 12h may be displayed and blinked with dotted lines. The first pattern may be variously determined according to a design.

As described above, lighting lines of a container area in which an unusable container is disposed are displayed in a different pattern from lighting lines of other container areas to provide a notification to the user about an unusable container. In addition, the display 461 of the knob 2 may also display a notification message about an unusable container. Accordingly, problems such as a trouble, a cooking failure, and an accident of the cooking apparatus 1 caused by an unusable container can be prevented.

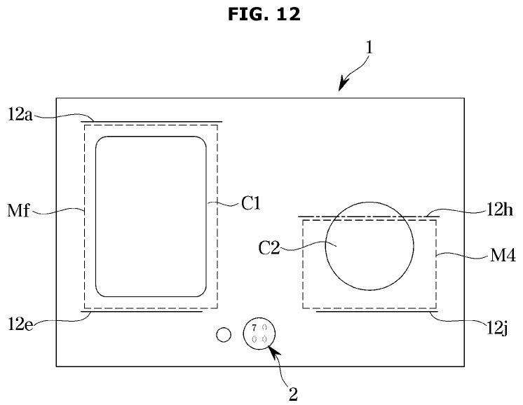

FIG. 12 is a view illustrating an example of light-emission of the lighting lines for a position error of a container.

Referring to FIG. 12, the controller 340 of the cooking apparatus 1 may determine a position error of a container on the basis of container information. In addition, the controller 340 may control the plurality of light-emitting elements 13 to emit light with a second pattern indicating the position error of the container through at least one lighting line 12. In FIG. 12, the second container C2 may be disposed differently from FIG. 11. Most of a lower surface of the second container C2 overlap the seventh heating coil 210g and the eighth heating coil 210h, but a part (for example, approximately ⅓ of the lower surface) of the lower surface of the second container C2 may be disposed at a position overlapping the sixth heating coil 210f That is, the second container C2 may be disposed on the eighth lighting line 12h.

Since most of the lower surface of the second container C2 is positioned on the seventh heating coil 210g and the eighth heating coil 210h, the controller 340 of the cooking apparatus 1 may set the fourth container area M4 including the seventh heating coil 210g and the eighth heating coil 210h. In addition, the controller 340 may control light-emitting elements 13 to emit light through the eighth lighting line 12h and the tenth lighting line 12j to indicate the fourth container area M4.

However, since the second container C2 is disposed on the eighth lighting line 12h and disposed out of the set fourth container area M4, the controller 340 may determine that the second container C2 is disposed wrongly. The controller 340 may control the light-emitting elements 13 to emit light with the second pattern through at least one of the eighth lighting line 12h and the tenth lighting line 12j. For example, the second pattern may be a blinking alternate long and short dash line. The eighth lighting line 12h may be displayed and blinked as the alternate long and short dash line. The second pattern may be variously determined according to a design.

As described above, as light with a specific pattern is emitted through a lighting line overlapping a container, the user may be guided to move the container to a correct position. In addition, the display 461 of the knob 2 may also display a notification message about a position error of the container. Accordingly, problems such as a trouble, a cooking failure, and an accident of the cooking apparatus 1 caused by a position error of a container may be prevented.

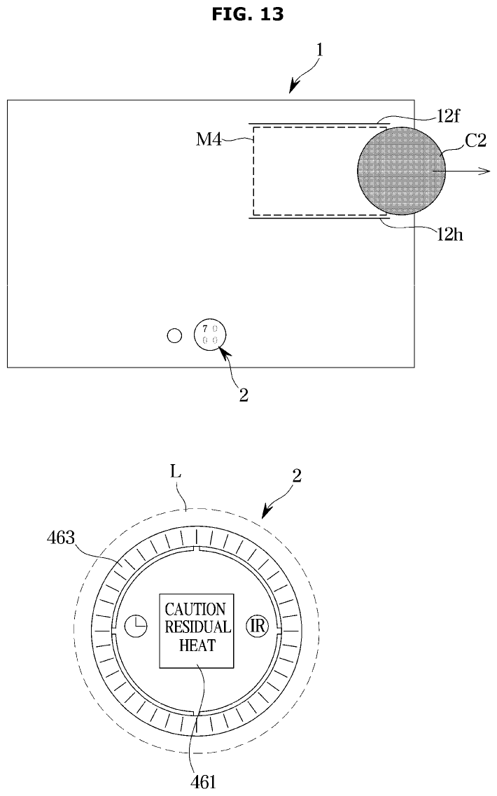

FIG. 13 is a view illustrating an example of light-emission of the lighting lines when residual heat is detected in a container area after cooking is completed.

Referring to FIG. 13, the controller 340 of the cooking apparatus 1 may control the plurality of light-emitting elements 13 to emit light with a third pattern indicating residual heat of a container area through at least one lighting line after cooking is completed in the container area of the plate 11. In addition, the controller 340 may control the knob 2 to output a notification message about the residual heat of the container area.

For example, as the second container C2 is disposed in the third container area M3, and the fifth heating coil 210e and the sixth heating coil 210f included in the third container area M3 operate, cooking in the second container C2 may be performed. When the cooking is completed in the third container area M3, the second container C2 may be removed from the third container area M3. However, heat may remain on a surface of the plate 11 corresponding to the third container area M3. Since an accident may occur when the user does not recognize that there is residual heat, it is necessary to provide a notification about the residual heat.

The controller 340 may control the light-emitting elements 13 to emit light with the third pattern through the sixth lighting line 12f and the eighth lighting line 12h indicating the third container area M3. The third pattern may be a straight line which becomes gradually shorter over time. That is, the sixth lighting line 12f and the eighth lighting line 12h may be displayed as straight lines which become gradually shorter over time. The third pattern may be variously determined according to a design. In addition, the display 461 of the knob 2 may display a notification message about residual heat of the third container area M3.

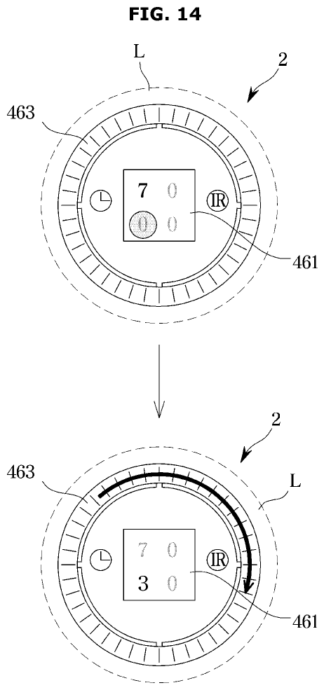

FIG. 14 is a view illustrating an example of heating power adjustment for specific container areas when a plurality of container areas are set.

Referring to FIG. 14, when a plurality of containers are disposed on the plate 11 or a command for setting a plurality of container areas is input through the knob 2, the display 461 of the knob 2 may display heating zone images or numbers corresponding to the plurality of container areas. In FIG. 14, an example in which numbers representing heating power of container areas are displayed on the display 461 of the knob 2 is illustrated as four container areas are set.

When a plurality of container areas are set, the controller 340 of the cooking apparatus 1 may determine a container area which is a control target container area (a target container area) among the plurality of container areas on the basis of a heating zone selection command input through the display 461 of the knob 2. The display 461 of the knob 2 may brightly display an image or a number indicating the target container area selected as the control target and darkly display images or numbers indicating the other container areas.

For example, when a touch input to a lower left number displayed on the display 461 of the knob 2 is received, the controller 340 may determine that the heating zone selection command for selecting the second container area M2 is input. Accordingly, the second container area M2 may be determined as a control target. After the second container area M2 is determined as the control target, the controller 340 may adjust heating power of the second container area M2 on the basis of rotation of the control wheel 463 of the knob 2.

Meanwhile, the controller 340 of the cooking apparatus 1 may stop an operation of the selected target container area on the basis of that a touch input corresponding to the heating zone selection command is maintained for a predetermined time in the knob 2. For example, when a touch input is received for a predetermined time (for example, two seconds) through a lower left number displayed on the display 461 of the knob 2, an operation of the heating coil 210 corresponding to the second container area M2 may be stopped and light of the lighting lines 12 corresponding to the second container area M2 may be turned off.

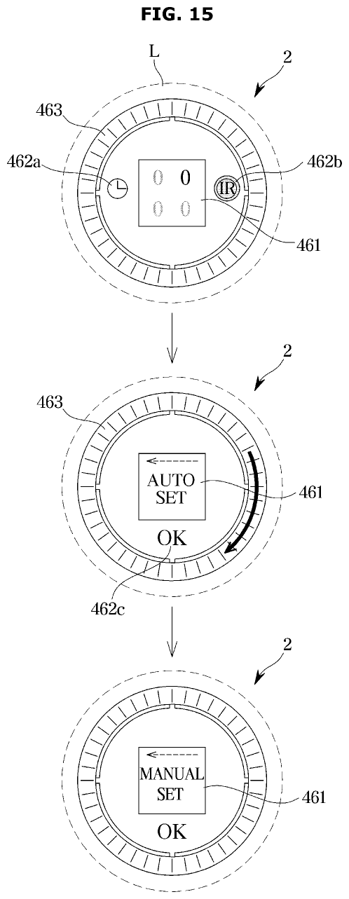

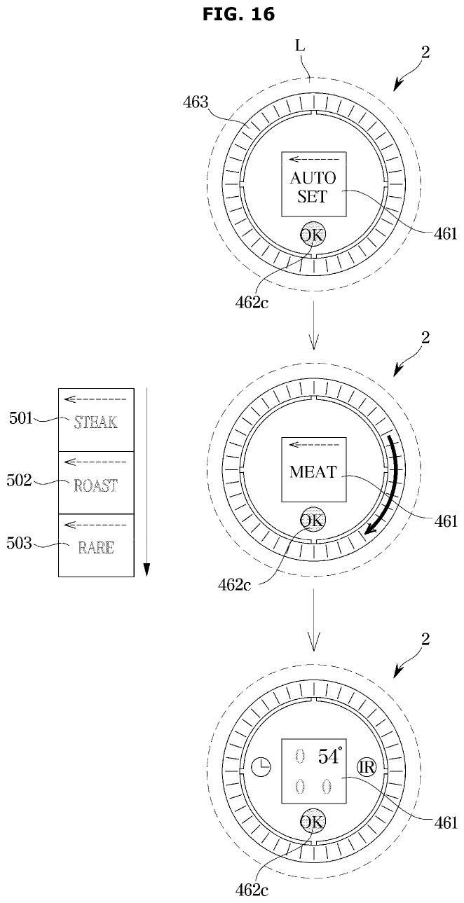

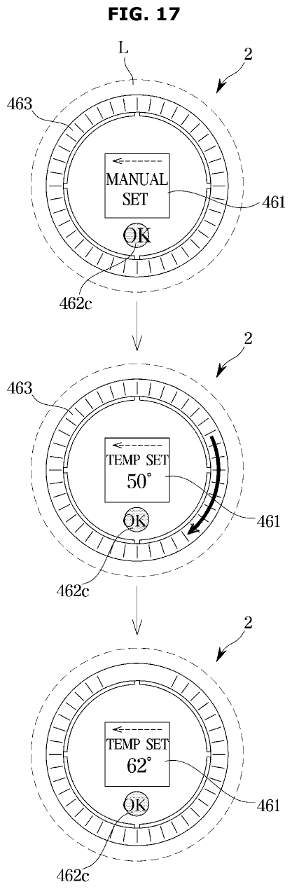

FIG. 15 is a view illustrating an example in which an automatic setting or a manual setting for a cooking temperature of a container area is switched by the knob. FIG. 16 is a view illustrating an example in which a cooking temperature of a container area is automatically set by the knob. FIG. 17 is a view illustrating an example in which a cooking temperature of a container area is manually set by the knob.

Referring to FIGS. 15, 16, and 17, the controller 340 of the cooking apparatus 1 may set a target temperature of a container area on the basis of a command input through the knob 2. In addition, the controller 340 may control the knob 2 to output a notification message when a temperature of a container positioned in the container area reaches the target temperature.

Specifically, referring to FIG. 15, the cooking apparatus 1 may enter the temperature set mode for a cooking temperature of a container area on the basis of a touch input through the temperature set button 462b of the knob 2. In addition, when the cooking apparatus 1 enters the temperature set mode, the manual set mode or the auto set mode may be switched for the cooking temperature of the container area on the basis of rotation of the control wheel 463. The cooking apparatus 1 may adjust a target temperature on the basis of rotation of the control wheel 463 in the manual set mode for the cooking temperature. In addition, the cooking apparatus 1 may search for a cooking menu on the bases of rotation of the control wheel 463 in the auto set mode for the cooking temperature.

For example, when the third container area M3 is selected as a control target, an image or a number positioned at an upper right end of the display 461 of the knob 2 may be displayed brightly. When the third container area M3 is selected as the control target, and a touch input to the temperature set button 462b of the knob 2 is received, the controller 340 of the cooking apparatus 1 may perform the temperature set mode for setting a cooking temperature of the third container area M3. The user may rotate the control wheel 463 to select the manual set mode or the auto set mode for the cooking temperature of the third container area M3. The display 461 of the knob 2 may display text such as “automatic setting” indicating the auto set mode or “manual setting” indicating the manual set mode.

Referring to FIG. 16, when a touch input for selecting the auto set mode is received through the confirmation button 462c of the knob 2, the controller 340 of the cooking apparatus 1 may control the knob 2 to display a cooking menu for automatically setting a cooking temperature of the third container area M3. The controller 340 may change the displayed cooking menu on the basis of rotating of the control wheel 463 of the knob 2. The user may rotate the control wheel 463 of the knob 2 to search for a cooking menu. In addition, when there is a top menu and a submenu dependent thereon, the submenu may be displayed on the display 461 of the knob 2 according to the selection from the top menu.

For example, as illustrated in FIG. 16, when “meat” is selected as a top menu, a first submenu 501 for selecting a type of meat (for example, tenderloin steak), a second submenu 502 for selecting a cooking method (for example, baking), and a third submenu 503 for selecting a cooking degree (for example, rare) may be displayed sequentially. The cooking apparatus 1 may automatically set a target temperature (for example, 54 degrees) of the third container area M3. The display 461 of the knob 2 may display the automatically set target temperature of the third container area M3.

Referring to FIG. 17, when a touch input for selecting the manual set mode is received through the confirmation button 462c of the knob 2, the controller 340 of the cooking apparatus 1 may adjust a target temperature on the basis of rotation of the control wheel 463 of the knob 2. The user may manually set the target temperature (for example, 62 degrees) of the third container area M3 by rotating the control wheel 463. When the control wheel 463 rotates clockwise, a target temperature may increase. A target temperature may be adjusted by 1 degree.

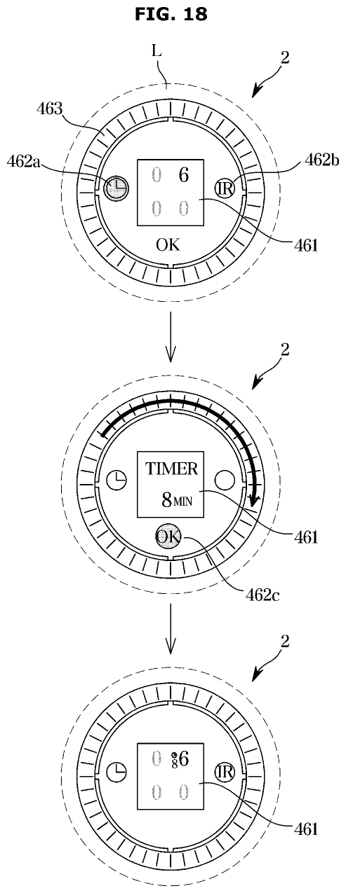

FIG. 18 is a view illustrating an example in which a cooking time of a container area is adjusted by the knob.

Referring to FIG. 18, the controller 340 of the cooking apparatus 1 may perform the time set mode for a cooking time of a container area on the basis of a touch input to the timer button 462a of the knob 2. The cooking apparatus 1 may adjust a cooking time of a container area on the basis of rotation of the control wheel 463 of the knob 2.

For example, when a touch input to the timer button 462a of the knob 2 is received while the third container area M3 is selected as a control target, the controller 340 of the cooking apparatus 1 may perform the time set mode for setting a cooking time of the third container area M3. The user may rotate the control wheel 463 to select the cooking time (for example, 8 minutes) of the third container area M3. After the cooking time is adjusted, when a touch input to the confirmation button 462c is received, the cooking time may be completely set.

The display 461 of the knob 2 may display the set cooking time and a remaining time according to a cooking progress. In addition, when the cooking time expires, a notification message indicating completion of the cooking may be output by the knob 2.

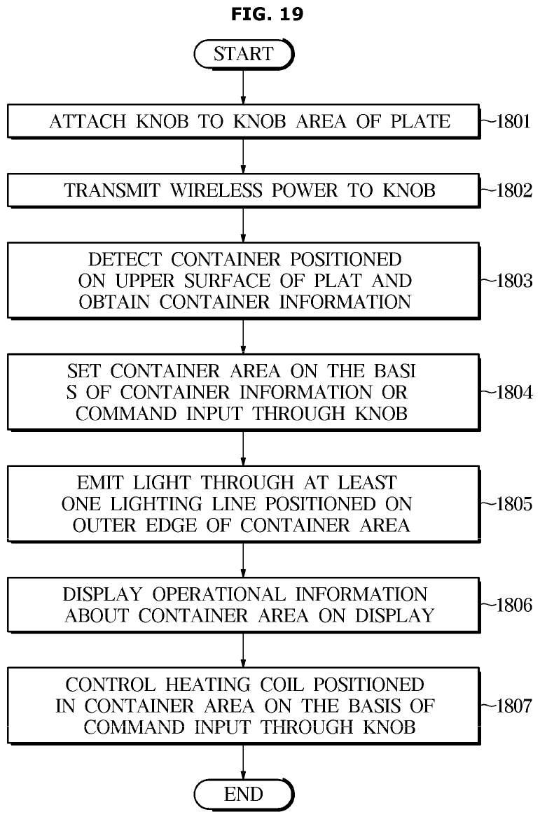

FIG. 19 is a flowchart for describing a method of controlling the cooking apparatus according to one embodiment.

Referring to FIG. 19, when the knob 2 is attached to the knob area 108 (1801), the cooking apparatus 1 may transmit wireless power to the knob 2 (1802). The knob 2 may receive the wireless power and operate.

The container sensor 321 of the cooking apparatus 1 may detect a container positioned on an upper surface of the plate 11 and obtain container information (1803). The container information may include a size, a position, and a type of the container. The controller 340 of the cooking apparatus 1 may set a container area M of the plate 11 on the basis of the container information obtained by the container sensor 321 or a command input through the knob 2 (1804). The controller 340 may set a container area on the basis of the size and the position of the container. In addition, the controller 340 may also set a container area according to the heating zone set command input through the knob 2. The container area may be set to correspond to a position of the heating coil 210.

The controller 340 of the cooking apparatus 1 may control the light-emitting elements 13 provided at a position of the lighting line 12 to emit light corresponding to the container area through at least one lighting line 12 provided on the plate 11 (1805). For example, when the container area is set, the controller 340 of the cooking apparatus 1 may control the light-emitting elements 13 to emit light through at least one lighting line 12 positioned on an outer edge of the container area among the plurality of lighting lines 12. The controller 340 may control the plurality of light-emitting elements 13 to emit the light with the predetermined first pattern through at least one lighting line on the basis of the type of the unusable container. The controller 340 may control the plurality of light-emitting elements 13 to emit light with the second pattern indicating a position error of a container through at least one lighting line 12. In addition, the controller 340 of the cooking apparatus 1 may control the plurality of light-emitting elements 13 to emit light with the third pattern indicating residual heat of the container area through at least one lighting line after cooking is completed in the container area of the plate 11.

The controller 340 of the cooking apparatus 1 may control the knob 2 to display operational information about the container area (1806). For example, the display 461 of the knob 2 may display the set container area using a heating zone image or a number. The display 461 of the knob 2 may display heating power, a temperature and/or a cooking time of the set container area. In addition, the display 461 of the knob 2 may display a greeting message for notifying that the cooking apparatus 1 is turned on, a notification message for an unusable container, a notification message for a position error of a container, and a notification message for residual heat of the container area.

The controller 340 of the cooking apparatus 1 may control at least one heating coil positioned in the container area among the plurality of heating coils 210 on the basis of a command input through the knob 2 (1807). For example, the controller 340 may determine a control target container area (a target container area) among the plurality of container areas on the basis of the heating zone selection command input through the knob 2. In addition, the controller 340 may adjust heating power of the target container area on the basis of rotation of the control wheel 463 of the knob 2.

As described above, in the disclosed cooking apparatus, the method of controlling the cooking apparatus, and the knob capable of controlling the cooking apparatus, information about a position of a container and an operating state of the cooking apparatus can be provided through the lighting line provided on the plate and the knob attached to the cooking apparatus. Accordingly, the user can intuitively check the operating state of the cooking apparatus.

In addition, in the disclosed cooking apparatus, the method of controlling the cooking apparatus, and the knob capable of controlling the cooking apparatus, an aesthetic effect can be improved by removing or minimizing an input and output interface other than the lighting line provided on the plate and the knob.

Another aspect of the present invention provides a method of controlling a cooking apparatus including supplying wireless power to a knob attached to a knob area of a plate, detecting a container positioned on an upper surface of the plate to obtain container information, setting a container area on the basis of the container information or a command input through the knob, emitting light through at least one lighting line positioned on an outer edge of the container area among a plurality of lighting lines provided on the plate by controlling a plurality of light-emitting elements, and displaying operational information about the container area on the knob.

The setting of the container area may include setting the container area on the basis of a size and a position of the container included in the container information or setting the container area on the basis of a heating zone set command input through the knob.

The emitting of the light through at least one lighting line may include determining a type of the container on the basis of the container information and emitting light with a predetermined first pattern through the at least one lighting line on the basis of the type of the unusable container.

The emitting of the light through at least one lighting line may include determining a position error of the container on the basis of the container information and emitting light with a second pattern indicating the position error of the container.

The method of controlling a cooking apparatus according to one embodiment may further include detecting a temperature of the plate and outputting a notification message about residual heat of the container area through the knob, and the emitting of the light through the at least one lighting line may include emitting light with a third pattern indicating the residual heat of the container area after cooking is completed in the container area of the plate.

The method of controlling a cooking apparatus according to one embodiment may further include detecting a temperature of the container, setting a target temperature of the container area on the basis of a command input through the knob, and outputting a notification message through the knob based on the temperature of the container reaching the target temperature.

The setting of the target temperature of the container area may include performing a temperature set mode for the cooking temperature of the container area on the basis of a touch input to a temperature set button provided on the knob and controlling a manual set mode or auto set mode to be switched for the cooking temperature of the container area on the basis of rotation of a control wheel provided on the knob.

Meanwhile, the disclosed embodiments may be implemented in the form of a storage medium storing computer-executable commands. The commands may be stored in the form of program code, and when the commands are executed by a processor, program modules may be generated to perform operations of the disclosed embodiments.

The machine-readable storage medium may be provided in the form of a non-transitory storage medium. In this case, the “non-temporary storage medium” is a tangible device, means that a signal (for example, an electromagnetic wave) is not included, and does not distinguish a case in which data is stored semi-permanently in a storage medium from a case in which data is stored temporarily in a storage medium. For example, the “non-temporary storage medium” may include a buffer in which data is temporarily stored.

Methods according to various embodiments disclosed in the present specification may be provided to be included in a computer program product. The computer program product may be traded between a seller and a buyer as a commodity. The computer program product may be distributed in the form of a machine-readable storage medium (for example, compact disc read only memory (CD-ROM)), distributed (for example, downloaded or uploaded) online through an application store (for example, Play Store™), or directly distributed between two user devices (for example, smartphones). In the case of the online distribution, at least a part of the computer program product (e.g. downloadable app) may be at least temporarily stored or generated in a machine-readable storage medium such as a memory of a manufacture's server, an application store's server, or a relay server.

The disclosed embodiments have been described with reference to the accompanying drawings as described above. It may be understood by those skilled in the art that the invention may be performed in other concrete forms without changing the technological scope and essential features. The disclosed embodiments are exemplary and should not be interpreted as purposes of limitation.

What is claimed is:

1. A cooking apparatus comprising:
a plate including:
a plurality of lighting lines and a knob area;
a plurality of light-emitting elements configured to emit light through the plurality of lighting lines;
a knob detachably attached to the knob area of the plate and configured to accept a command input;
a display on the knob;
a container sensor configured to detect a container positioned on an upper surface of the plate;
a communication device configured to communicate with the knob; and
a controller configured to:
set, based on container information obtained by the container sensor or a command input through the knob, a container area on the plate,
control the plurality of light-emitting elements to emit light through at least one lighting line, among the plurality of lighting lines, positioned on an outer edge of the container area, and
control the knob to display operational information about the container area.

2. The cooking apparatus of claim 1, wherein
the controller sets the container area based on a size and a position of the container detected by the container sensor and included in the container information, or sets the container area based on a heating zone set command input through the knob.

3. The cooking apparatus of claim 1, wherein
the controller
determines a type of the container based on the container information, and
controls the plurality of light-emitting elements to emit light with a predetermined pattern through the at least one lighting line based on the type of the container being unusable.

4. The cooking apparatus of claim 1, wherein
the controller
determines a position error of the container based on the container information, and
controls the plurality of light-emitting elements to emit light with a pattern indicating the position error of the container through the at least one lighting line.

5. The cooking apparatus of claim 1, further comprising:
a temperature sensor configured to detect a temperature of the plate,
wherein, after cooking is completed in the container area of the plate, the controller
controls the plurality of light-emitting elements to emit light with a pattern indicating residual heat of the container area through the at least one lighting line, and
controls the knob to output a notification message about the residual heat of the container area.

6. The cooking apparatus of claim 1, further comprising:
a plurality of heating coils arranged between the plurality of lighting lines under the plate,
wherein the controller controls at least one heating coil among the plurality of heating coils, positioned in the container area, based on the command input through the knob.

7. The cooking apparatus of claim 1, further comprising:
a container temperature sensor configured to detect a temperature of the container,
wherein the controller
sets a target temperature of the container area based on the command input through the knob, and
controls the knob to output a notification message based on the temperature of the container reaching the target temperature.

8. The cooking apparatus of claim 7, wherein
the knob includes:
a temperature set button, and
a control wheel configured to be rotatable; and
the controller
performs a temperature set mode for a cooking temperature of the container area based on a touch input to the temperature set button, and
controls a manual set mode or auto set mode to be switched for the cooking temperature of the container area based on rotation of the control wheel.

9. The cooking apparatus of claim 8, wherein
the controller
adjusts the target temperature based on the rotation of the control wheel in the manual set mode, and
controls the knob to display a cooking menu based on the rotation of the control wheel in the auto set mode.

10. The cooking apparatus of claim 1, wherein
the knob includes:
a timer button, and
a control wheel configured to be rotatable; and
the controller
performs a time set mode for a cooking time of the container area based on a touch input to the timer button, and
adjusts the cooking time of the container area based on rotation of the control wheel.

11. The cooking apparatus of claim 1, wherein
the display of the knob is configured to receive a touch input, and
upon setting a plurality of container areas, the controller determines a container area among the plurality of container areas to be a control target based on a heating zone selection command input through the display of the knob.

12. The cooking apparatus of claim 11, wherein
the controller stops an operation of a selected container area based on the touch input corresponding to the heating zone selection command being maintained for a predetermined time.

13. The cooking apparatus of claim 1, wherein
the knob further includes:
a housing, and
a lighting module provided in the housing and configured to emit light through a lower surface of the housing upon the knob being attached to the knob area.

14. A method of controlling a cooking apparatus, the method comprising:
supplying wireless power to a knob attached to a knob area of a plate, the knob including a display;
detecting a container positioned on an upper surface of the plate to obtain container information;
setting a container area based on the container information or a command input through the knob;
controlling a plurality of light-emitting elements to emit light through at least one lighting line among a plurality of lighting lines provided on the plate, the at least one lighting line being positioned on an outer edge of the container area; and
displaying operational information about the container area on the knob.

15. The method of claim 14, wherein
the setting of the container area includes:
setting the container area based on a size and a position of the container included in the container information, or
setting the container area based on a heating zone set command input through the knob.
